(19) United States
(12) Patent Application Publication
(10) Pub. No.: US 2008/0233549 A1
(43) Pub. Date: Sep. 25, 2008

(54) BODY ANATOMIE VISUAL AID GARMENTS

(76) Inventor: Sue Daniels, Banner Elk, NC (US)

Correspondence Address: SIMMONS PATENTS, P.O. BOX 1560, LENOIR, NC, 28645, US

(21) Appl. No.: 12/053,519

(22) Filed: Mar. 21, 2008

Related U.S. Application Data
(60) Provisional application No. 60/896,028, filed on Mar. 21, 2007.

(51) Int. Cl. G09B 23/28; A41D 1/00

(52) U.S. Cl. 434/267; 2/1

(57) ABSTRACT

One embodiment of the apparatus includes clothing depicting a selected body anatomy so that when the clothing is associated with the body to be massaged the clothing presents the location of the body system of interest. Such clothing preferably forms a visual aid that is associated with a body to be massaged that shows (a) the location of a muscle system (with or without labels) perhaps including a split view overlaying muscles and underlying muscles, (b) a skeletal system depicting bony landmarks and origin, insertion and function of attached muscles, (c) a lymphatic system showing circulation paths, (d) the nine regions and quadrants of a human body, and (e) the location of organs and acupressure points including chakras. Such a visual aid would preferably be useful for allowing a student to better comprehend the meaning of terms such as medial, lateral, prone, and supine and the locations of body “landmarks.”

### CLAIM TO PRIORITY

This application claims priority to provisional application 60/896,028 filed on Mar. 21, 2007, the entire contents of which are incorporated herein by this reference for all purposes.

### TECHNICAL FIELD OF THE INVENTION

The present invention relates to an apparatus and method for aiding a person in learning the anatomy of a body and related massage therapy for parts of such body.

### BACKGROUND OF THE INVENTION

Massage therapy is generally defined as the practice of manually or mechanically applying structured forces on the body to achieve a beneficial response where such forces include vibrations, pressure, tension, and other forms of motion. Such energy is typically directed to the soft tissues of the body, including muscles, connective tissue, tendons, ligaments, joints, lymphatic vessels, organs of the gastrointestinal system and reproductive system. A massage may be restricted to a specific part of a body or it may encompass the entire body with a general goal of aiding the healing process, relieving psychological stress, managing pain, and/or improving circulation. Consequently, massage therapy may be performed by many practitioners including professional Massage Therapists, Physical Therapists, Chiropractors, and Osteopaths.

Typically, massage therapy is given to a client while the client is lying on a massage table, sitting upright in a massage chair, or lying on a pad on the floor with the client generally unclothed or partially unclothed with parts of the client's body being “draped” with a covering such as towels or sheets. There are many types of massages and massage techniques including, barefoot deep tissue, Bowen therapy, chair massage, Chinese Tui Na massage, Chinese Zhi Ya massage, CranioSacral therapy, deep muscle therapy, deep tissue massage, Effleurage, foot massage, hot stone massage, Lomilomi, Mayan abdominal massage, Muscle Energy Technique (MET), Myofascial Release, Myoskeletal alignment technique (MAT), Neuromuscular therapy (NMT), Petrissage, Roman Massage, Rolfing, Scalp massage, Shantala massage, Shiatsu, Soft Tissue Therapy, Trigger point therapy, Myofascial (muscle and fascia) therapy, Sports Massage and Sports Therapy, Stone massage, Structural muscular balancing, Swedish massage, Tai Ji Massage (Tai Chi Massage), Te Tao Ching, Tai Ji Massage Qi Diagnosis, That massage, and trigger point therapy.

To become skillful at administering massage therapy, different levels of training are required depending on the level of proficiency desired and the technical challenges associated with a particular massage therapy. For example, the Lomilomi massage is said to be an ancient Hawaiian art where Lomilomi specialists were taught their art over decades by Lomilomi masters. Today, most people wishing to become skilled in administering massage therapy attend an accredited massage therapy school. Agencies such as the Commission on Massage Therapy Accreditation (COMTA), Accrediting Commission of Career Schools and Colleges of Technology (ACCST), Accrediting Council for Continuing Education and Training (ACCET), Accrediting Bureau of Health Education Schools (ABHES), and the National Accrediting Commission of Cosmetology Arts and Sciences (NACCAS), are recognized by the U.S. Department of Education as specialized accrediting agency for bodywork programs.

While there are numerous types of massages and massage techniques, all such massages and massage techniques require a comprehensive knowledge of the anatomical makeup of the body to be massaged. For example, Zhi Ya requires specific knowledge of pinching points and acupressure points. Performing Deep Tissue Massage generally requires focused massage work on a specific joint, muscle or muscle group. Similarly, Trigger Pont Therapy applies manual pressure to trigger points. A trigger point is an area of a muscle (about 50 cells) that may relay pain sensations to other parts of the body. With the proper pressure, duration and location, immediate release of tension and improved muscular functioning may occur.

Such specialized knowledge requires disciplined study for a sufficient period of time where the anatomical makeup of the body to be massaged is explored. While many charts and similar study aids have been developed to aid the student in mastering the knowledge required for a particular massage therapy, the prior art has overlooked at least one type of visual aid; a visual aid that is physically associated with the body to be message.

What is needed is a visual aid that is associated with a body to be massaged that shows, for example, (a) the location of a muscle system (with or without labels) perhaps including a split view overlaying muscles and underlying muscles, (b) a skeletal system depicting bony landmarks and origin, insertion and function of attached muscles, (c) a lymphatic system showing circulation paths, (d) the nine regions and quadrants of a human body, and (e) the location of acupressure points including chakras. Such a visual aid would preferably be useful for allowing a student an insightful understanding of terms such as medial, lateral, prone, and supine. In addition, there is a need for a visual aid that provides labels for providing information such as proper pressure to be applied, duration in time the pressure is to be applied, body part names, landmark names and location.

### SUMMARY

Some of the objects and advantages of the invention will now be set forth in the following description, while other objects and advantages of the invention may be obvious from the description, or may be learned through practice of the invention.

Broadly speaking, a principle object of the present invention is to provide a visual aid for learning an anatomical feature/system of a body comprising a garment that is associated with a body where the garment comprises an anatomical system image (ASI) depicting the anatomical system of interest.

Another general object of the present invention is to provide a visual aid as described above that includes labels identifying the component parts of the anatomical system of interest.

Another general object of the present invention is to provide a visual aid as described above that includes specialized information for performing a message therapy.

Another general object of the present invention is to provide a visual aid as described above where the labels include at least one of: muscle name, bone name, origin points, insertion points, function information, pressure information including pressure duration and pressure location, organ location, acupressure point locations, and trigger point locations.

Yet another general object of the present invention is to provide a visual aid as described above comprising a garment comprising a plurality of layers where each layer depicts a different anatomical system of interest and where the layers are organized in the same order as they would be in the body and wherein such layers can be removed or folded back so that inter garment layers may be viewed.

Yet another general object of the present invention is to provide a visual aid as described above including pointers without labels so that a student is reminded that a particular item has a name but requiring the student to recall the name.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps, or features hereof may be practiced in various uses and embodiments of this invention without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures or stated in the detailed description).

One exemplary embodiment of the present invention relates to novel clothing garments comprising an anatomical-system-image (ASI) for a body on an outer surface of the garment. When the garment is associated with a body, the ASI preferably depicts the locations of the component parts of the anatomical system of interest. For one embodiment, the ASI may comprise a jump suit type structure comprising a front side and an opposing back side and is configured for associating with a human body. The jump suit contains an anterior view of a skeletal system on the front side and a posterior view of such skeletal system on the opposing side. For one embodiment the jump suit structure is a complete body suit including hands and feet. Alternative embodiments include a jump suit type structure comprising a plurality of sections.

For this embodiment, the ASI may depict any anatomical system (or parts of such system) of interest including the skeletal system, lymphatic network, nervous system, respiratory system, endocrine system, digestive system, urinary system, circulatory system, outer muscles, deep muscles.

The ASI may further comprise information tags/labels including: muscle name, bone name, origin points, insertion points, function information, pressure information including pressure duration and pressure location, organ location, acupressure point locations, and trigger point locations.

The garment may further comprise layers with each layer comprising an ASI for a particular anatomic system. Such layers are preferably in order as they would be found in the body of interest. For a human body, the garment may have a skeletal layer, one or more organ layers, and then one or more muscle layers.

One embodiment for the human body comprises a jump suit structure comprising a plurality of layers mechanically associated with each other so that upper layers may be removed or folded back to view a lower layer. For one embodiment, layers include a skeletal layer, then a urinary layer showing the location of the kidneys, then a digestive layer, then a deep muscle layer and an outer muscle layer.

The ASI may include lines pointing to specific locations on the image to provide a visual prompt indicating such specific location has a particular name or function.

For yet another embodiment, the ASI may be configured with labels, such as a bar code label that provides instruction to a machine or person on what type of message therapy to perform and how such therapy is to be performed.

Additional embodiments of the present subject matter, not necessarily expressed in this summarized section, may include and incorporate various combinations of aspects of features or parts referenced in the summarized objectives above, and/or features or components as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a garment comprising an ASI showing the anterior view of a skeletal system for a human body;

FIG. 1b is a garment as shown in FIG. 1 presenting an alternative color scheme;

FIG. 2 is a garment comprising an ASI showing the posterior view of a skeletal system for a human body;

FIG. 2b a garment as shown in FIG. 2 presenting an alternative color scheme;

FIG. 3 is a multi-piece garment having a top piece and a bottom piece, both comprising an ASI showing the anterior view of a skeletal system for a human body;

FIG. 4 is a garment comprising an ASI showing the circulatory system and skeletal system for a human body;

FIG. 5 is a garment comprising an ASI showing an anterior view of outer muscle system of a human body;

FIG. 6 is a garment comprising an ASI showing a posterior view of outer muscle system of a human body where the ASI further comprises an information-tag;

FIG. 7 is a garment comprising an ASI showing the posterior view of a skeletal system where the ASI further comprises alignment marks and further showing one exemplary embodiment of an information-tag-garment;

FIG. 8 is an exploded view of a multi-layered garment comprising an ASI showing a skeletal system layer, urinary system layer, digestive system layer, an inner muscle layer and an outer muscle layer.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only, and is not intended as limiting the broader aspects of the present invention.

For the purposes of this document two or more items are “associated” by bringing them together or into relationship with each other in any number of ways including a direct or indirect physical connection that may be releasable (snaps, rivets, screws, bolts, etc.) and/or movable (rotating, pivoting, oscillating, etc.).

It will be appreciated that while this document contains headers, such headers are place markers only and are not intended to form a part of this document or affect its construction. While the exemplary embodiments described in this document relate mainly to items configured for teaching and learning massage therapy for humans, the present invention may also be used and configured for teaching and learning in any number of fields of study relating to any animal body's anatomy.

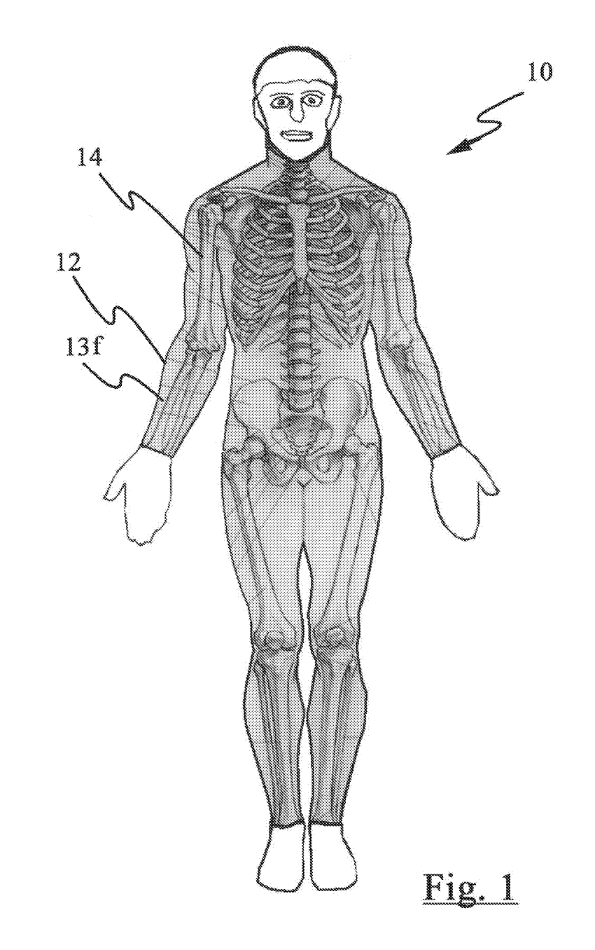

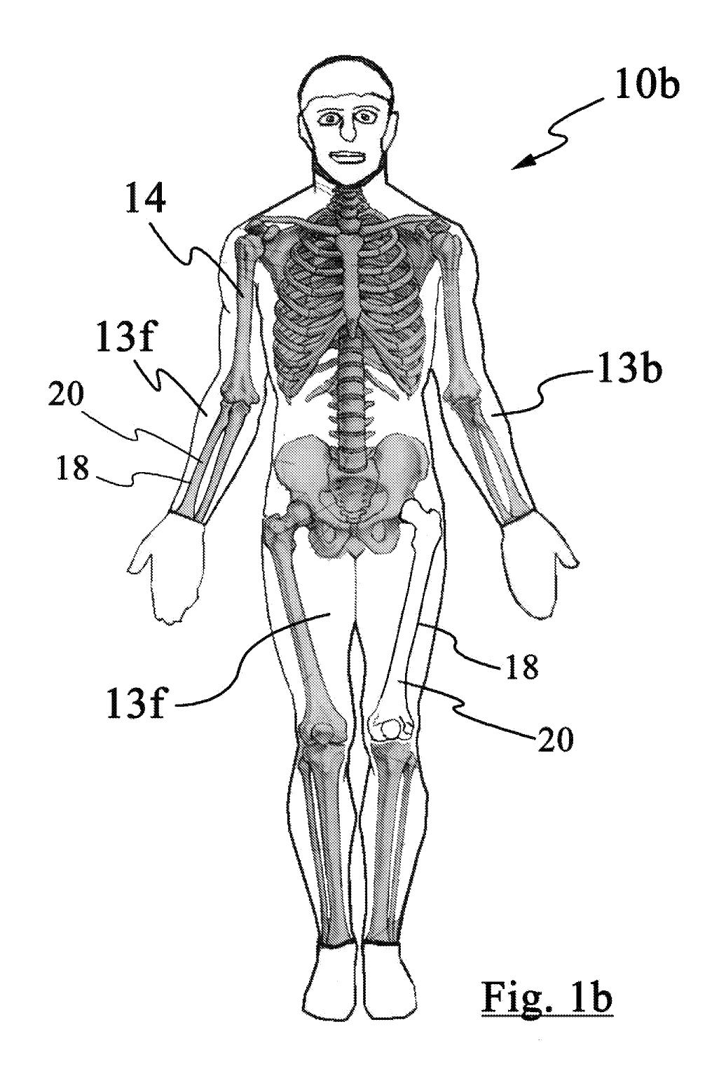

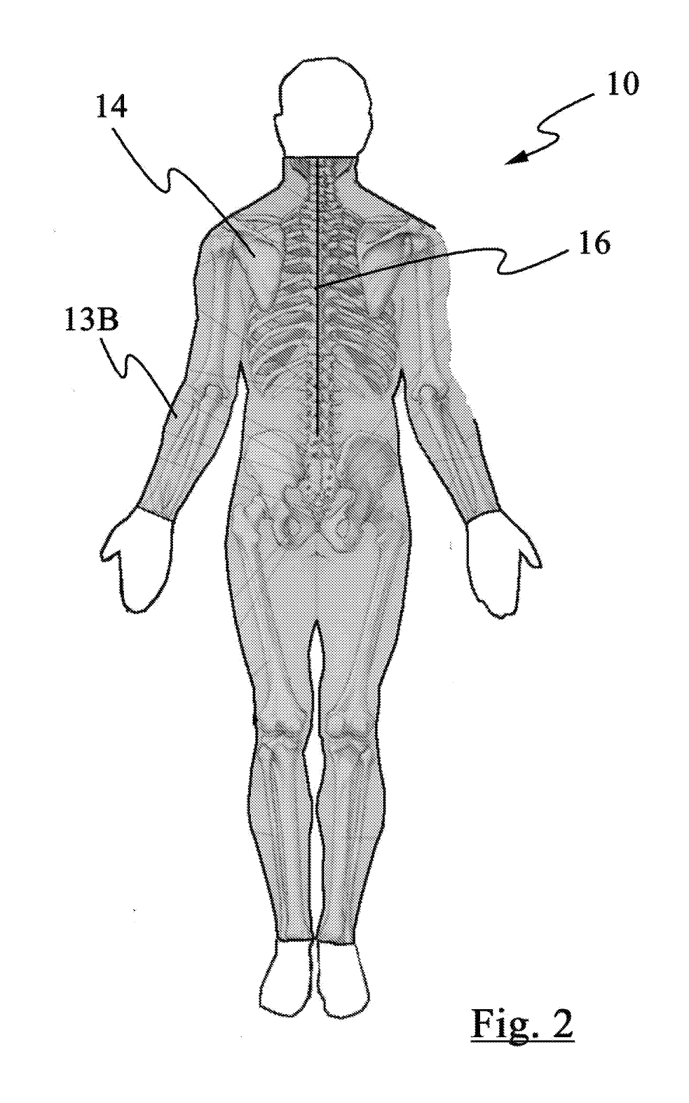

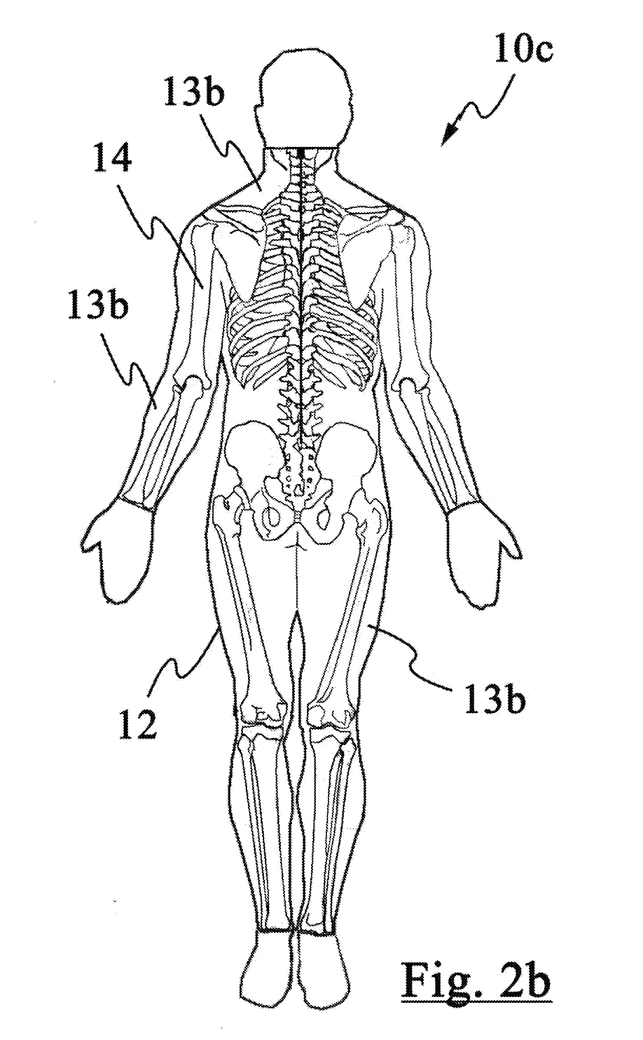

Referring now to FIG. 1, one exemplary embodiment of the invention depicts ASI garment (10) in a one-piece jumpsuit (12) configuration. Associated with the garment is an image (front view) of a substantially complete human skeletal system. For this embodiment, jumpsuit (12) will be described as presenting two visual-aid-sections: background-sections (13f) and image-sections (14). The background-sections are simply the sections of the garment that surround the image-sections. The image-sections are the sections of the garment that define at least part of an image for a body system. Image-sections are defined by the image-outline (18) and the image-interior (20). For the embodiment presented in FIG. 1, background-sections (13f) present a background color that is substantially the same as the image-interior (20) color. It should be appreciated that any colors schemes fall within the scope of the invention. For example, FIG. 1b depicts background sections (13f) as defining a first color, image-outline (18) defining a second color and image-sections (14) defining a third color. Similarly, FIG. 2b depicts background sections (13b) and image-interior (20) as defining a first color while image-outline (18) defines a second color.

FIG. 2 presents a substantially complete back view of jumpsuit (12) depicting a back view of a substantially complete human skeletal system. For the back side of jumpsuit (12), background sections (13b) may or may not define the same color as image-sections (14). Jumpsuit (12) further comprises a latching device (16). For the present embodiment, latching device (16) is Velcro that defines a slightly visible seam along the spine. Other suitable latching devices may be used such as zippers, magnets, buttons, and snaps. For this embodiment of the invention, background sections (13f) and background sections (13b) are the substantially the same color; however, it should be appreciated that such sections may define different colors to provide a visual aid in learning terms such as prone, and supine as well as other useful information.

Background-sections (12) and/or Image-sections (14) may include information-tags positioned at the appropriate location(s) on the image-section (14) (and or background-section) where such information-tags present information including bony landmarks, origin, insertion, function of an attached muscle, pinching points, acupressure points, and chakras. For example, if a client (wearing an embodiment of the disclosed invention) indicates that it is difficult or hurts to move his right arm, a massage therapist need only look at the information-tags to determine which muscles are associated with the client's describe problem. The message theorist may then focus on that muscle or muscle group.

Jumpsuit (12) is preferably made from a material designed to fit closely to the body of interest (like a stocking fits to a leg). Restated, jumpsuit (12) preferably “fits” so that the image presented by image-sections (14) is in substantial alignment with the body part depicted by image-section (14). For the examples above, jumpsuit (12) is to fit tightly against a human body so that the skeletal system images defined by image-sections (14) are in alignment with the body's skeletal system. One of ordinary skill in the art will appreciate that such a configuration will “project” the locations of a body's skeletal components to an observer. Any suitable material may be used to manufacture garment (10) including stretch knitted fabrics such as Boiled wool, Bunting, Double knits, Four-way stretch knits, Interlock knits, Jersey, Milanese, Power net, Raschel knits, Rib knits, Single knits, Stable knits, Stretch knits, Stretch velour, Sweater knits, Sweatshirt knits, Tricot, and Two-way stretch knits.

It will be appreciated that the present invention may be used in any suitable garment configuration including: shirts, leotards, bodysuits, and jumpsuits. As depicted in many of the figures in this document, garment (10) does not include hands. It should be appreciated that garment (10) configurations that include hands and/or feet fall within the scope of the invention. In addition, the image-sections (14) by depict any body system of interest including one or more body systems such as muscular, skeletal, organ, digestive, respiratory, circulatory, musculoskeletal, and nervous system.

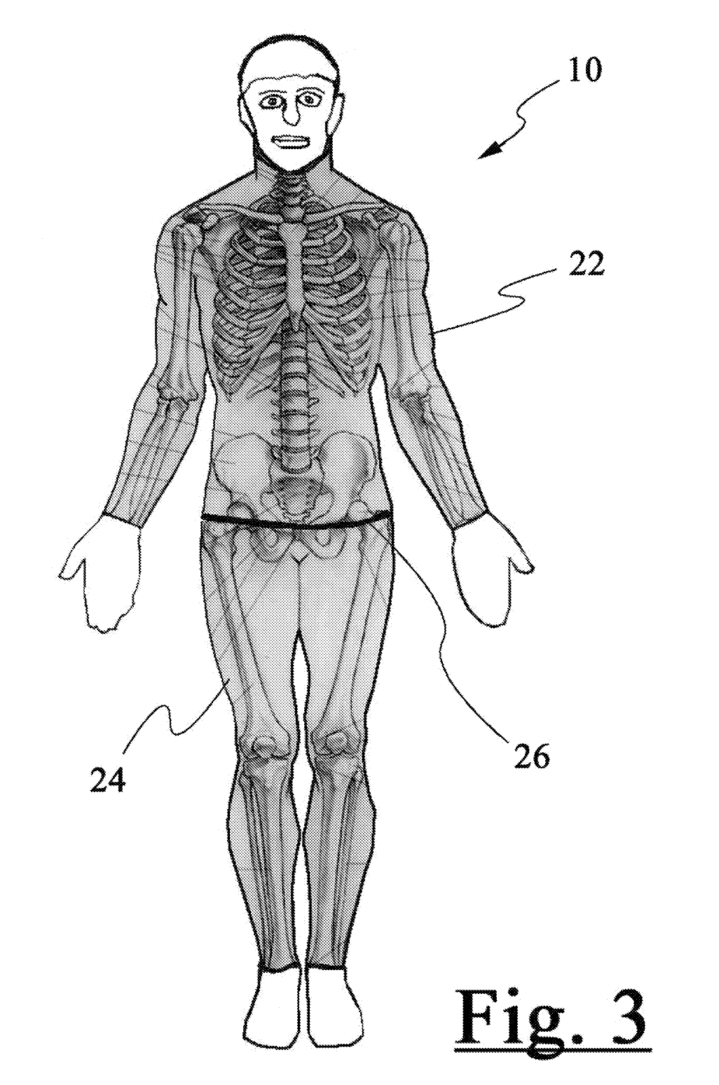

FIG. 3 presents an alternative embodiment of the invention where garment (10) defines a two-piece garment having a top-section (22) and a bottom-section (24). When associated with a body, one of top-garment (22) and bottom-garment (24) define a transaction-point (26) that marks the end of a first garment and the beginning of the second garment.

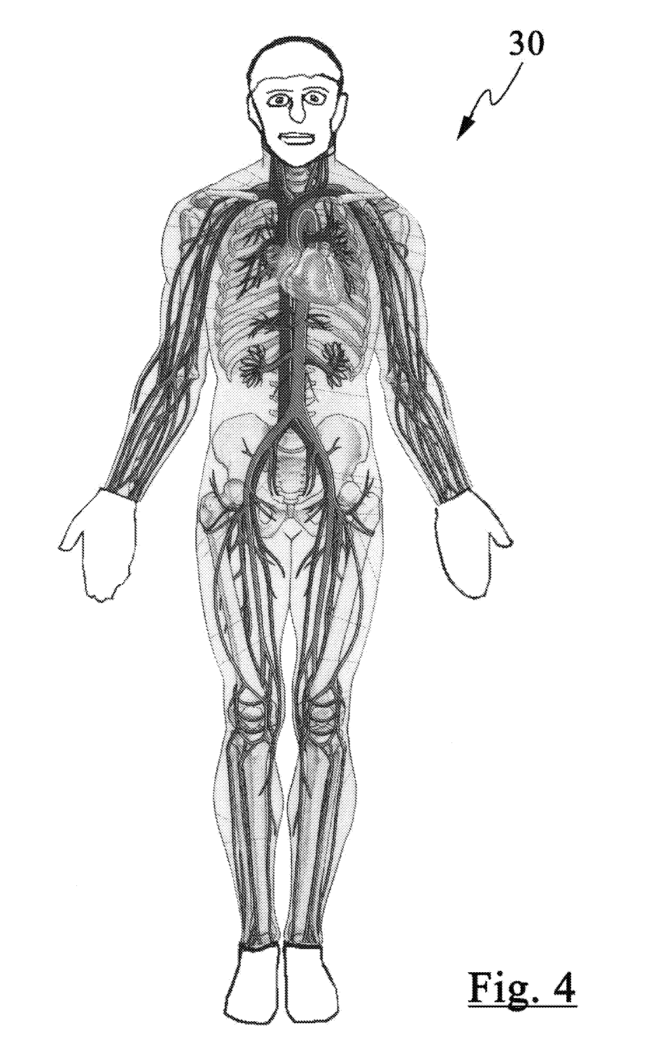

FIG. 4 presents one exemplary embodiment of the invention where garment (10), in a jumpsuit (12) configuration, defines an image-section (14) presenting two body systems; a substantially complete skeletal system and (b) a substantially complete lymphatic network. For the presently preferred exemplary embodiment of garment (10) the two body-systems are combined into a signal image-section (14). Restated, the image of the skeletal system cannot be disassociated from the image of the lymphatic.

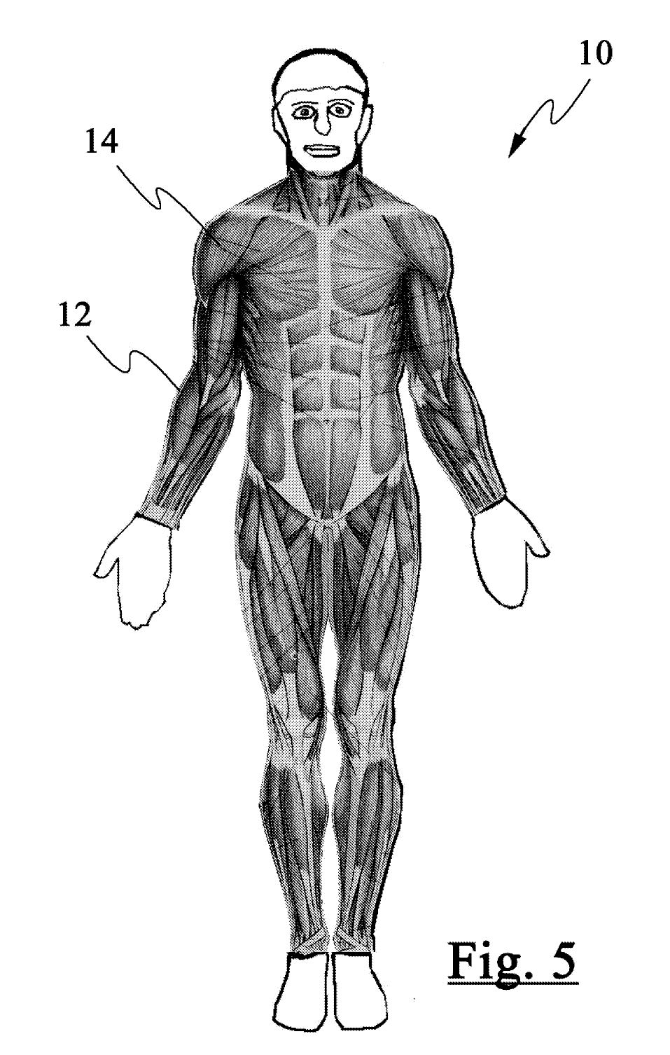

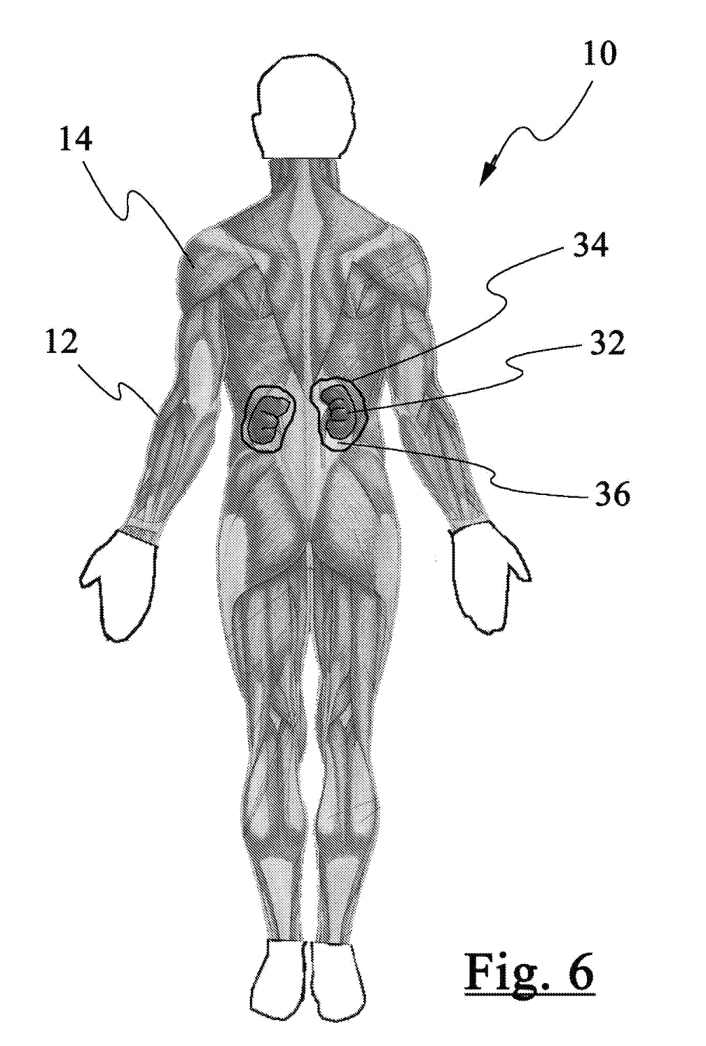

FIG. 5 and FIG. 6 present yet another exemplary embodiment of garment (10), in a jumpsuit (12) configuration, comprising only one visual-aid-section; image-section (14). For this embodiment, image-section (14) presents a substantially complete view of an overlaying muscle system for a human body. For this embodiment, the image-section (14) covers substantially the entirety of the surface of garment (10). Such an embodiment is useful to deep tissue massage therapists (for example) particularly when the image-section (14) is associated with massage-messages and warring-messages as described below.

Similarly, where a body system of interest is composed of layers, one side of image-section (14) may present a first layer while the opposing side if image-section (14) presents a second layer. By way of example, for the muscular system depicted in FIG. 6 above, one side of image-section (14) may depict a human body's overlaying muscle system while the opposing side of image-section (14) depicts a human body's underlying muscles.

FIG. 6 presents a back view of the garment (10) configuration shown in FIG. 5 depicting yet another exemplary feature of the invention. Associated with a section of image-section (14) are two information-tags (34). Such information-tags (34) relate to the location of a human kidney. Information tag (34) defines a body-part-region (36) and then presents an image of the body part (e.g. kidney). The body-part-region (36) simply provides an indication of the probable location of the relevant body part. Information tags may comprise any type of information desired including: (a) muscle names, (b) bone names, (c) origin points, (d) insertion points, (c) pressure information including pressure duration and pressure location, (f) organ location, (g) acupressure point locations, (h) trigger point locations, (i) warning criteria, (j) general information, (k) massage criteria, (l) treatment criteria, and (m) electronic coding symbol (such as a bar code).

Warning-criteria is information (in text or symbolic form) warning a therapist of actions not to take or to take, depending on the circumstances. Treatment-criteria is information (in text or symbolic form), that defines particular treatment actions. Examples of electronic coding include a bar code position at various locations along the surface of garment (10). For this embodiment, a user scans a bar code associated with a body part of interest. The bar code data is transferred to an electronic processing device that causes instructional images to be display on a display device and/or activation of an audio device that plays an audio message.

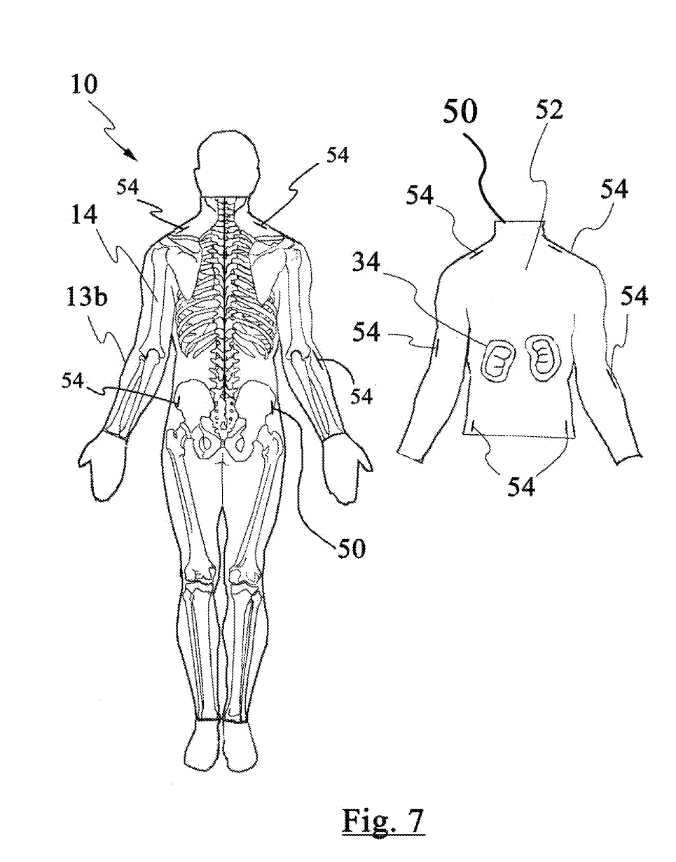

For the example provided in FIG. 7, information tag (34) relates to a human kidney. Such information-tag (34) comprises an information-tag-image (32) which is an image of a human kidney. Information tag (34) further includes a line that surrounds the information-tag-image (32) thereby defining a body-part-region (36). Body-part-region (36) simply defines the area above the expected internal location for the body part of interest. As noted above, information-tags (36) may further include information such as massage criteria. For such example, the massage criteria for the example above may simply be, “Do Not Massage.” It should be appreciated that information-tags (34) may be associated with garment (10) in any number of ways including embodiments where information-tags (34) are a part of image-section (14).

Referring now to FIG. 7, an embodiment of the invention is depicted where information-tags (34) are disposed on information-tag-garment (50). Such information-tag-garment (50) preferably comprises transparent-section (52) which defines a garment section that is a least partially transparent/translucent so that the underlying image-section (14) associated with garment (10) can be seen. Information-tag-garment (50) further defines one or more information-tag section(s) where information-tags (34) are disposed. Such information-tag-sections are preferably composed of the same type of material as transparent-section (52). Such information-tag-sections may or may not be transparent as desired for the configuration of interest.

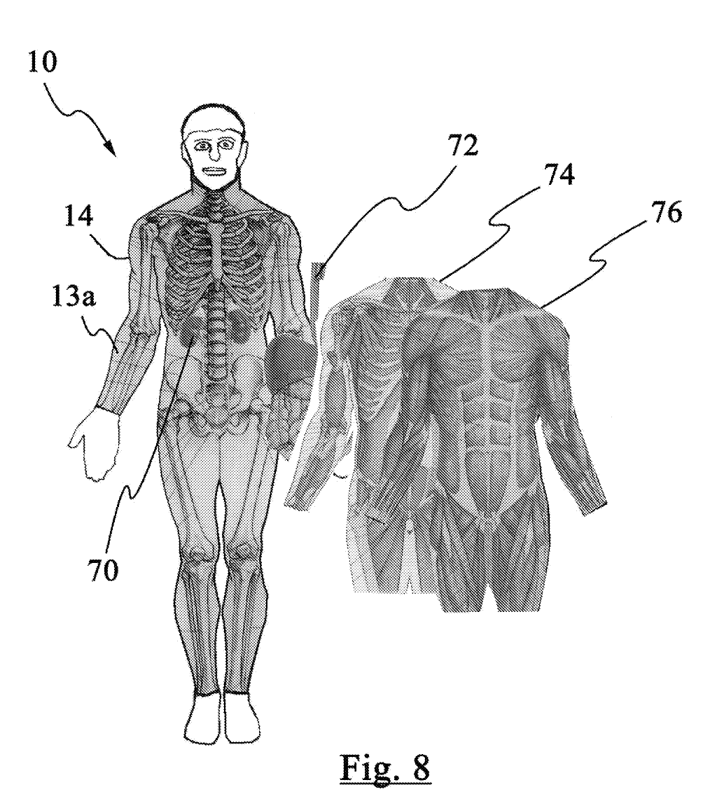

Such information-tag-garment (50) may be configured as any garment type described earlier, however, for the preferred embodiment, information-tag-garment (50) is a pull over garment comprising alignment marks (54). Alignment marks (54) allow the information-tag-garment (50) to be easily positioned so that the information-tag-section(s) is properly aligned. For such embodiments of the invention, garment (10) further includes corresponding alignment marks (54) as shown in FIG. 8. Alignment marks (54) may further define attachment-devices for associating information-tag-garment (50) with garment (10). Such attachment-devices may be Velcro, buttons, snaps, magnetic strips, or other suitable devices for releasably associated two items together. Alternatively, for some embodiments, neither information-tag-garment (50) nor garment (10) comprise alignment marks (54)

It should be appreciated that information-tag-garment (50) may comprise a plurality of information tags. For example, labels for the entire underlying image depicted by image-section (14) may be disposed on information-tag-garment (50). As before, such information tags may include: (a) warning criteria, (b) general information, (c) function descriptions, (d) massage criteria, (e) treatment criteria and other information as described earlier.

Referring now to FIG. 8, yet another embodiment of the invention is presented showing exemplary embodiments of anatomic-system-attachments. Anatomic-system-attachments are garments or garnet accessories that depict an anatomic system. For the embodiments depicted in FIG. 8, the base garment (10) depicts a skeletal system as previously described. Associated with a surface of garment (10) is an anatomic-system-attachment (70) depicting a urinary system. Other anatomic-system-attachments shown include a digestive system (72), an underlying muscular system (74) and an overlying muscular system (76). Such anatomic-system-attachments may be configured as any garment type described earlier and be of any size or shape suitable for the application of interest. For the preferred embodiment, however, anatomic-system-attachment (70) is a 2-dimensional layer (i.e. not a shirt but half of a shirt, front or back, if you will) that is associated to one side of garment (10). Such anatomic-system-attachments may be associated with garment (10) with any attachment devices described earlier. In addition,

It should be appreciated that while the exemplary embodiment of the invention depicted in FIG. 8 may comprise multilayer configuration, such a configuration may still be considered a one piece garment for the purposes of this document. More specifically, for multilayered embodiments were at least a portion of each layer is not easily disassociated from the garment, such a configuration is a one piece garment. Examples of “not easily disassociated” include rivets, sowed seams, and zippers that do not completely separate at one end. Examples of layers that can be easily disassociated include snaps, magnetic strips, and zippers that separately completely.

The above described garment (10), image-sections, information-tags, anatomic-system-attachments may be generally configured to teach a body's anatomy. In addition, such devices may be further configured for more specific purposes such as teaching therapies performed by many practitioners including professional Massage Therapists, Physical Therapists, Chiropractors, and Osteopaths.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A body anatomy visual aid garment configured for conveying anatomical information relating to a body, said body anatomy visual aid comprising:
a garment comprising a visual-aid-section depicting at least one anatomic feature of said body wherein said garment is manufactured from a stretchable fabric configured to fit tightly against said body so that the depiction of said at least one anatomic feature is in substantial alignment with the depicted feature; and
at least one information-section associated with said garment, wherein said at least one information-section defines an information-tag that present information related to an anatomic feature adjacent to said information-tag.

2. A body anatomy visual aid garment as in claim 1, wherein a first side of said garment comprises a visual-aid-section depicting a front view of a substantially complete overlaying muscle system for a human body and a second opposing side of said garment comprises a substantially complete overlaying muscle system for a human body.

3. A body anatomy visual aid garment as in claim 2, where in said information-tag includes at least one of warning-criteria and massage-criteria for a predefined massage therapy.

4. A body anatomy visual aid garment as in claim 3, wherein said information-tag includes a bar code.

5. A body anatomy visual aid garment as in claim 3, wherein said garment is a one piece jumpsuit.

6. A body anatomy visual aid garment as in claim 3, wherein said garment is a two piece garment.

7. A body anatomy visual aid garment as in claim 1, wherein said garment is further configured for being associated with an information-tag-garment.

8. A body anatomy visual aid garment as in claim 7, wherein said garment further comprises at least one alignment-mark configured for facilitating proper alignment of said information-tag-garment relative to said garment.

9. A body anatomy visual aid garment as in claim 8, wherein said at least one alignment-mark comprises an attachment device for releaseably associating said information-tag-garment with said garment.

10. A body anatomy visual aid garment configured for conveying anatomical information relating to a body, said body anatomy visual aid comprising:
a garment comprising a visual-aid-section depicting at least one anatomic feature of said body wherein said garment is configure to closely associate with said body so that said visual-aid-section is in substantial alignment with the corresponding anatomic feature for the body;
wherein said garment is further configured for being associated with an information-tag-garment; and
wherein said garment further comprises at least one alignment-mark configured for facilitating proper alignment between said garment and said information-tag-garment.

11. A body anatomy visual aid garment as in claim 8, wherein said at least one alignment-mark comprises an attachment device for releaseably associating said information-tag-garment with said garment.

12. A body anatomy visual aid garment as in claim 10, wherein a first side of said garment comprises a visual-aid-section depicting a front view of a substantially complete overlaying muscle system for a human body and a second opposing side of said garment comprises a substantially complete overlaying muscle system for a human body.

13. A body anatomy visual aid garment as in claim 12, where in said information-tag-garment includes at least one of warning-criteria and massage-criteria for a predefined massage therapy.

14. A body anatomy visual aid garment as in claim 13, wherein said information-tag-garment includes a bar code.

15. A body anatomy visual aid garment as in claim 14, wherein said garment is a one piece jumpsuit.

16. A body anatomy visual aid garment configured for conveying anatomical information relating to a body, said body anatomy visual aid comprising:
a garment comprising a first base layer comprising a first visual-aid-section depicting at least one anatomic feature of said body wherein said garment is configure to snugly associate with said body so that said visual-aid-section is in substantial alignment with the corresponding anatomic feature for the body;
a second layer movably associated with said first layer wherein said second layer comprises a second visual-aid-section depicting a second anatomic feature of said body; and
wherein at least one side of said second layer is configured for being disassociated from said first layer allowing said second layer to be folded back thereby exposing said first layer.

17. A body anatomy visual aid garment as in claim 16, wherein said first visual-aid-section depicts a substantially complete front view of the skeletal system for a human body and wherein said second visual-aid-section depicts a substantially complete front view of a underlying muscle system for a human body.

18. A body anatomy visual aid garment as in claim 17, further comprising a third layer movably associated with said first layer wherein said third layer comprises a third visual-aid-section depicting a substantially complete front view of a overlaying muscle system for a human body.

19. A body anatomy visual aid garment as in claim 17, wherein at least one visual-aid-section comprises an information-tag comprising at least one of warning-criteria and massage-criteria for a predefined massage therapy.

20. A body anatomy visual aid garment as in claim 3, wherein said garment is a one piece jumpsuit.
